(19) United States
(12) Patent Application Publication
(10) Pub. No.: US 2018/0289025 A1
(43) Pub. Date: Oct. 11, 2018

(54) SHRIMP PEELING MACHINE

(71) Applicant: Seapeeler APS, Saeby (DK)

(72) Inventor: Thomas VITTRUP, Saeby (DK)

(21) Appl. No.: 15/570,637

(22) PCT Filed: May 4, 2016
(86) PCT No.: PCT/DK2016/050114

§ 371 Date: Oct. 30, 2017

(30) Foreign Application Priority Data
May 7, 2015 (DK) PA 2015 70265

(51) Int. Cl. A22C 29/02; F16H 7/02

(52) U.S. Cl. CPC A22C 29/026; F16H 7/023; A22C 29/021

(57) ABSTRACT

Shrimp peeling machine (1) including a closed chain (3) including cylindrical rolls (4,5,6), (7) and includes first rolls (4), second rolls (5) and third rolls (6) and where at least the first (4) and second (5) rolls in a limited area—the peeling area (8)—are designed to turn by an activation element (9). The shrimp peeling machine (1) includes a first motor device (10), which drives the activation element (9) and another motor device (11), which drives the chain (3) forwards in the shrimp peeling process direction (7). The activation element (9) includes at least one toothed belt (12) with a first action surface (13) and another action surface (14). The first action surface (13) is with first items (15) in mesh with the first roll (4) and the second action surface (14) is with second items (16) in mesh with the second roll (5).

### CROSS-REFERENCE TO RELATED APPLICATIONS

This application is a U.S. national stage of International Appl. No. PCT/DK2016/050114 filed 4 May 2016, which claimed priority to Danish Appl. No. PA 2015 70265 filed 7 May 2015, which applications are all incorporated herein by reference in their entireties.

### TECHNICAL FIELD

The invention relates to a shrimp peeling machine including a closed chain consisting of a number of parts, which include cylindrical rolls, which cylindrical rolls' longitudinal axis is orientated 90 degrees in relation to a shrimp peeling process direction and includes first rolls with a diameter D1 and second rolls with a diameter D2 and third rolls with a diameter D3 smaller than both D1 and D2, and where at least the first and second rolls in a limited area—the peeling area, are designed to turn by an activation element and that the third rolls are placed between the first rolls and the second rolls and by a spring or similar, which presses the third rolls against the first and second rolls, is designed to be operated by rotation of the first and second rolls, which machine also includes a first motor device, which operates the activation element and another motor device, which drives the closed chain forwards in the shrimp peeling process direction.

### BACKGROUND

From U.S. Pat. No. 8,777,701 is known a shrimp peeling machine of the in the introduction stated type. It is desirable to improve parts of the driving mechanism in this, such that the rolls' direction of rotation, speed and number of rotations per time unit can to a higher degree be regulated and adjusted, which is difficult to achieve with the construction stated in the mentioned patent.

It is thus the object of the present invention to provide a shrimp peeling machine, which does not have the known technique's drawbacks, or which at least provides a useful alternative to the known technique.

### SUMMARY OF THE INVENTION

This is achieved with a shrimp peeling machine of the in the introduction stated type and where the activation element also includes at least one toothed belt including a first action surface and a second action surface, which first action surface with first items is in mesh with the first roll, and which second action surface with second items is in mesh with the second roll.

The first and second rolls thus drive the third rolls, between themselves, for rotation, and they thereby have the same rotating direction, while the third rolls have the opposite rotating direction.

The shrimp peeling machine includes a closed chain consisting of a number of parts, which contain and carry the cylindrical rolls, where the cylindrical rolls' longitudinal axis is angled 90 degrees in relation to the shrimp peeling process direction, which is also the chain's direction of movement.

The first and second rolls are turned by activation of first and second items consisting of for example toothed wheel or friction wheel, which are driven forwards by use of at least one toothed belt/friction belt, which is connected to a motor device. The toothed wheels or the friction wheels, which consist the first and second items are each mounted on a shaft, which is placed in continuation of the belonging cylindrical roll's rotational axis and is connected directly hereby.

The toothed wheels are activated by at least one toothed belt, which is driven by an activator such as a servomotor. By toothed belt should in this context also be understood driving belts, which have such good contact/friction to the first and second items that the belt's movement causes rotation of the items and thereby the rolls, and that the belt does not slip, but that the whole translational movement becomes transferred to the rotation.

The shelling of the shrimps occurs by the shrimp being moved between the rotating rolls. The rolls have different diameters such that the first rolls have the diameter D1, which is smaller than the second rolls' diameter D2. The third rolls' diameter D3 is smaller than both D1 and D2. This combination of changing diameters of the rolls have been shown to be optimum with regard to shelling or peeling of shrimp efficiently.

The shrimp peeling process itself is carried out by the chain being driven forwards in a shrimp peeling process direction where shrimp, which are to be peeled, are added to the chain's rolls in the top at an inlet to a horizontal course for the chain. The shrimps are subsequently shelled by friction through contact to the rolls, which are driven by activation of the toothed belt/the toothed belts. The rolls are thus rotated simultaneously with them being moved forwards by the chain's propulsion in the shrimp peeling process direction.

The released shrimp shell parts are collected under the chain and the shelled and thus finally peeled shrimps can be collected at the end of the chain by a horizontal outlet, where the chain's horizontal course enters into a return channel, which is placed under the horizontal course and back to the inlet end. Collection chute for shrimp shells is placed between the horizontal upper course and the return channel for the chain.

Since there are used toothed belts/friction belts to rotate the toothed wheel/friction wheels and thereby the first and second rolls, it is possible to carry out a random rotation of the rolls, since it is observed that the first rolls always rotate with the second rolls for ensuring of the third rolls' rotation.

The driven first and second rolls can thus be rotated in a direction a random number of times and subsequently the opposite direction a random number of times. Hereby, it is possible to carry out an optimum shrimp peeling process, since rotational speed and the number of rotations can adjust the size of the shrimps and their degree of maturation.

Shrimps in the known processes are often artificially matured in order to ease the off peeling. The artificial maturation can here be reduced to a minimum, since one, by the flexible adjustment of the cylinders/the rolls, can regulate retention time for the shrimps in the peeling area and also how large a friction they are exposed to, since the circulation rate can also be adjusted.

There can be used one long toothed belt, which by an appropriate contact has contact surface against the first rolls' toothed wheel and with a contact surface has also got contact against the second rolls' toothed wheels and thus drives them synchronously.

There can also be used to separated toothed belts, where one toothed belt drives toothed wheel belonging to the first rolls, while the second toothed belt drives toothed wheel belonging to the second rolls. The two toothed belts become driven such that the rolls/cylinders operate synchronously.

The rolls' toothed wheels do not touch each other, so the wear of the toothed wheel is minimal. It has also got the effect that it is only in the peeling area that the rolls rotate, which is why that the wear on them is also small.

By installation of the shrimp peeling machine in shrimp trawlers, the shrimp peeling process can be optimized by speed adjustment of the motor, which drives the chain, and by speed adjustment of the toothed belt/the toothed belts, which drive the cylindrical rolls.

The shrimp peeling machine can be mounted and operated in maritime vessels such as shrimp trawlers. It is achieved that shrimps in an uninterrupted process can be landed in a shrimp trawler and subsequently boiled, peeled and packaged on the vessel and thus be ready for sale to the consumers as soon as the trawler is in port.

The quality of the sales ready peeled shrimps will thereby be significantly higher than it has hitherto been possible, just as the production process is optimized and is thereby made inexpensive, among other since the whole shrimp manufacturing process is joined on the fishing vessel, which lands the shrimps and since the maturing process and the time for processing is minimized. Hereby is also achieved a better quality of the peeled shrimps. The shrimp peeling machine can obviously also be used for shrimp peeling on land.

In an additionally preferred embodiment, the activation element includes two toothed belts, a first toothed belt and a second toothed belt, which toothed belts are operated by the first motor device, and that the first toothed belt operates the first rolls and that the second toothed belt operates the second rolls.

By having two separated toothed belts for operating respectively the first rolls and the second rolls, wear on the toothed belt surfaces becomes distributed on two separated toothed belts. Furthermore, it can be more simple to mount two belts instead of only one toothed belt, since they are each just let over a few driving rolls in the two end areas and are furthermore driven by the servomotor, which by a separate toothed belt drive operates the driving rolls. The rolls are driven synchronously and thus have the surface/periphery speed.

In an additionally preferred embodiment, the first items include toothed wheel first toothed wheel with a number of teeth t1 and where the first toothed wheel is connected to a first roll and the second items include second toothed wheel with a number of teeth t2 and every other toothed wheel is connected to the second rolls, which number of teeth and diameters of the rolls are designed such that the peripheral rotational speed for the rolls is the same when the toothed wheels are in mesh with the toothed belt/the toothed belts, which by the construction have the same speed since the teeth on the different wheels are uniform.

Hereby, the optimum mutual rotational relation of the first rolls and the second rolls is achieved, such that they between themselves can drive the third rolls only by the surfaces' rolling against each other and fully without slipping between the third rolls' surfaces and respectively the first and second rolls' surfaces.

In an additionally preferred embodiment, the diameter D1 is smaller than the diameter D2 and the number of teeth t1 is smaller than the number of teeth t2.

An appropriate value for D1 is 63.5 mm and for t1 20 teeth; while an appropriate value for D2 is 76 mm and for t2 24 teeth.

The small barrel/cylindrical roll, that is the third roll, has a diameter D3 of 12 mm.

In an additionally preferred embodiment, the toothed wheels are in mesh with the toothed belt/the toothed belts in the peeling area and the toothed wheels are designed for not touching each other. The toothed wheels do not, at any time, touch each other, during the whole shrimp peeling process.

Since the toothed wheels, which are placed opposite and are not connected rotatably to respectively the first and second rolls, the rolls are rotated when the toothed wheels rotate. Since the toothed wheels are not in mesh with each other at all during the chain's whole propulsion and nor in the peeling area, is achieved small wear on the rolls, since the first and second rolls thus only roll towards the third rolls in the peeling area, as a result of the toothed wheels being driven around the peeling area by the toothed belt/the toothed belts.

In an additionally preferred embodiment, the first motor device is a servo gear, which can be programmed to a random propulsion of the toothed belt/the toothed belts, by which the first and second rolls rotate in the interval 10 degrees to infinite in one direction and in the interval 10 degrees to infinite in opposite direction, preferably in the interval 20 degrees to 30 000 degrees, and more preferred in the interval 180 to 20 000 degrees and by which rotations the third roll turns around in the shrimp peeling area. Hereby, the processing of the shrimps can be regulated and the machine can be set for the optimum, with regards to rotation of the rolls as function of the shrimps' size and degree of maturation. By infinite number of degrees should here be understood that the rolls do not change rotational direction, but are set for continuous operation in one and the same direction. A rotation is converted to 360 degrees, whereby for example 20.000 degrees gets to correspond to about 55 rotations.

In an additionally preferred embodiment, the rolls have a metallic or a polymeric surface and the first and second rolls have a polymeric surface and the third rolls have a metallic surface.

The shrimps are shelled by friction between the activated rolls and the released shells are collected under the chain's upper horizontal course.

In an additionally preferred embodiment, the chain is designed to run continuously forwards and the first and second rolls in the peeling area are designed to rotate in changing directions and opposite each other, by which rotation the third rolls turn around.

In an additionally preferred embodiment, the first rolls form a first plane and the second rolls form a second plane, and the first plane i is placed in vertical direction above the second plane.

In an additionally preferred embodiment, the shrimp peeling machine includes a cleaning station, which cleaning station is placed under the peeling area.

In an additionally preferred embodiment, the activation element is placed in the shrimp peeling area.

In an additionally preferred embodiment, the first action surface, and the second action surface, are the same surface.

This is the case when there is only one toothed belt, where a specific surface on the toothed belt will be the one, which has contact against both the first toothed wheel and the second toothed wheel. However, it will obviously be a time lag, where the first surface becomes the second surface.

In an additionally preferred embodiment, the first action surface is different from the second action surface. It is the case when the machine includes 2 separated toothed belts for driving respectively the first toothed wheels and the second toothed wheels.

In an additionally preferred embodiment, the toothed belts/the toothed belt are driven by toothed belt-toothed wheels.

In an additionally preferred embodiment, the toothed wheels, which drives the cylindrical rolls, are mounted on a shaft, which is placed in continuation of a cylindrical roll's rotational axis.

Generally, it should be noted about the invention that it consumes less water, namely about 75% less in relation to the known machines. The quality of the shrimps is better, by use of the present invention, in relation to shrimps peeled with the machines, which are on the market, since there occurs less dilution of the shrimps, since they are not matured artificially in such decidedly degree, which it is the case by use of the known machines.

The variable speed of the chain and on the rotation of the rolls means precise peeling degree and larger yield of 1.5-2% in relation to the traditional shrimp peeling.

Wear of the cylinders is more even, since wear occurs on the whole surface. The toothed belt system is very cleaning-friendly. Cleaning of the cylinders occurs in the area under the peeling process, wherefore the cylinders are always clean and there is therefore no need for operation stop for the sake of cleaning.

### BRIEF DESCRIPTION OF THE DRAWINGS

The invention will now be explained more fully with reference to the drawing, where

FIG. 1 shows a section of a preferred embodiment of a shrimp peeling machine according to the invention.

FIG. 2 shows a section of the chain shown in FIG. 1, which is used for shelling or peeling shrimps.

### DETAILED DESCRIPTION OF THE INVENTION

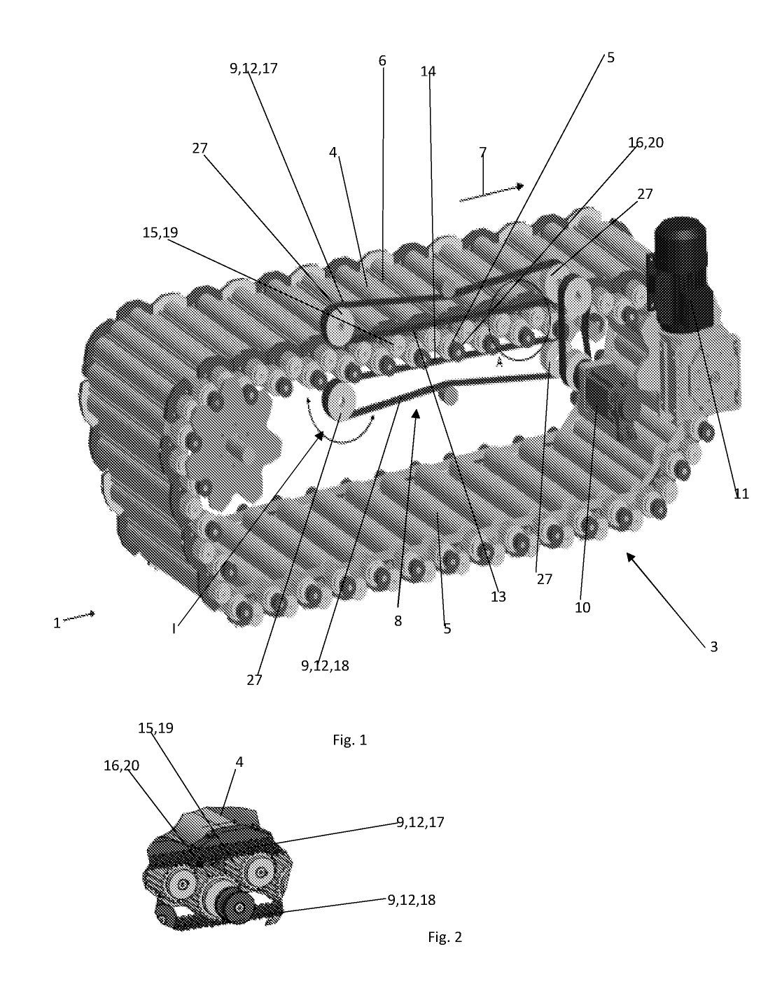

FIG. 1 shows a section of a preferred embodiment of a shrimp peeling machine 1 according to the invention. It includes a closed chain 3 consisting of a number of parts, which include cylindrical rolls 4,5,6. The cylindrical rolls' 4,5,6 longitudinal axis is placed 90 degrees in relation to a shrimp peeling process direction 7. The rolls include first rolls 4 with a diameter D1 and second rolls 5 with a diameter D2 and third rolls 6 with a diameter D3. The rolls have a metallic or a polymeric surface, where the first 4 and second 5 rolls have a polymeric surface and the third rolls 6 have a metallic surface.

The rolls are placed in relation to each other such that the third rolls 6 are placed between the first 4 rolls and the second 5 rolls. By a spring, the third 6 rolls are pressed towards the first 4 and second 5 rolls. By rotation of the first and second 5 rolls, the third roll 6 thus spins around. The first rolls 4 and the second rolls 5 are thus not in direct touch with each other, and they are thereby also movable in the same or each own rotational direction. By the third rolls' 6 touch of both a first roll 4 to the one side and another roll 5 to the other side, there occurs an indirect connection between the first and second rolls, such that a first roll's rotational direction is transferred to a third roll, which thereby gets to have an opposite rotational direction, which is then additionally transferred from here to an adjacent second roll, which has consequently got opposite rotational direction in relation to the third roll, but thereby has the same rotational direction as the first roll. The first rolls 4 form a first plane and that the second rolls 5 form another plane and the first plane in a peeling area 8, meaning the area of the machine where the shrimps are peeled, is in vertical direction placed above the second plane.

The first 4 and second 5 rolls rotate in the peeling area 8 by use of an activation element 9, which is driven by a first motor device 10 consisting of a servomotor, which can be programmed. Another motor device 11 drives the closed chain 3 forwards in the shrimp peeling process direction 7.

The activation element 9 includes a toothed belt 12 and in the shown example two toothed belts: a first toothed belt 17 and a second toothed belt 18. The first toothed belt 17 has a first action surface 13 and the second toothed belt 18 has a second action surface 14, The first action surface 13 is with first items 15 consisting of a first toothed wheel 19 in mesh with the first roll 4, since the first action surface 13 is grooved and drives the toothed wheels around by friction. The toothed wheels are thus connected, not rotatably, to the rolls, wherefore the toothed wheels' rotation is transferred directly to the roll. The second action surface 14 is with second items 16 consisting of a second toothed wheel 20 in mesh with the second roll 5. The power transmission is the same as for the first rolls.

The toothed wheels are mounted on the same axis as the rolls rotate around, but a toothed wheel and the roll, which it is connected to, are fixed connected to each other.

The first toothed wheel 19 has a number of teeth t1 and the second toothed wheel 20 has a number of teeth t2. The second toothed wheels 20 are each connected to another roll 5. The number of teeth and diameters of the rolls are designed such that the periphery rotational speed for the rolls 4,5 is the same when the toothed wheels 19,20 are in mesh with the toothed belt/the toothed belts 12,17,18.

The shown first motor device 10 is a servo drive, which can be programmed to a random propulsion of the toothed belt/the toothed belts 12,17,18, by which the first and second rolls 4,5 are rotated. The toothed belts are each stretched out between two driving rolls 27 placed in each own end of the shrimp peeling area. The rotation of the rolls can be everything in the interval 10 degrees to infinite in one direction and in the interval 10 degrees to infinite in opposite direction. The rotation is preferably in the interval 20 degrees to 10 000 degrees. By the rotations, the third roll 6 turns around in the shrimp peeling area 8. The changing rotational direction is indicated by the arrow I.

The chain 3 is designed to run continuously forwards and the first 4 and second 5 rolls in the peeling area 8 are designed to rotate in changing directions. By the rotations, the third rolls 6 are as mentioned made to spin around or rotate.

FIG. 2 shows a section of the chain, which is used for shelling or peeling shrimps. It shows the first rolls 4, which are placed in a plane, and the second rolls, which are placed in a, in relation to the first rolls, vertically displaced plane. In between, the third roll is placed, since it by friction against the first and second rolls spins around by their rotation. The third roll/cylinder runs up against the large cylinders, the first cylinder, such that surface speed is the same. Since the three cylinders/rolls have different diameter (preferably: ø76.5, ø63.5, ø12), the rotation number is not the same. The small ø12 cylinder with ø12 thus runs ø76.5/ø12=6.37 times more rotations than the first roll.

The described combination of varying diameters and surfaces of the included rolls 4,5,6 have shown to be optimal with respect to shelling or peeling shrimp efficiently. A shrimp-peeling process is carried out by the chain 3 being driven in a rotational direction, as indicated by the arrow 7, where shrimps, which are to be peeled, are added to the chain 3 in the top at the start to the horizontal course.

The shrimps are subsequently shelled by friction through contact to the rolls 4,5,6, which are driven by the activation element 9.

The released shrimp shell parts are collected under the chain 3 and the shelled shrimps can be collected at the end of the chain 3 by the horizontal outlet.

By installation of the shrimp peeling machine in shrimp trawlers, the shrimp peeling process can be optimized by speed adjustment of the second motor device 11, which drives the chain 3 forwards and around, and by speed adjustment of the first motor device 10 (and thereby the toothed belt/the toothed belts), which drive the cylindrical rolls 4,5,6.

It is a part of the invention that the shrimp peeling machine 1 is mounted and driven in maritime vessels such as shrimp trawlers.

With the invention is achieved that shrimps, in a continuous process, can be landed in a shrimp trawler and subsequently boiled, peeled and packaged on the vessel and thus be ready for sale to the consumers as soon as the trawler is in harbor.

The quality of the sales ready peeled shrimps will thereby be significantly higher than it has hitherto been possible and the production process is optimized and is thereby made inexpensive, among others since the whole shrimp manufacturing process is gathered on the fishing vessel, which lands the shrimps.

The shrimp peeling machine can obviously also be used on land and installed in buildings.

1.-10. (canceled)

11. A shrimp peeling machine, comprising:
a closed chain having one or more cylindrical rolls, wherein the longitudinal axis of each cylindrical roll is orientated 90 degrees in relation to a shrimp peeling process direction, and wherein the one or more cylindrical rolls comprises one or more first rolls with a diameter D1, one or more second rolls with a diameter D2 and one or more third rolls with a diameter D3, wherein D3 is smaller than both D1 and D2;
a first motor device configured to operate a activation element, wherein the first rolls and the second rolls are configured to be turned by the activation element in a peeling area, and wherein the activation element comprises at least one toothed belt including a first action surface and a second action surface, wherein the first action surface with first items is in mesh with the first roll, and wherein the second action surface with second items is in mesh with the second roll; and
a second motor device configured to drive the closed chain in the shrimp peeling direction;
wherein the third rolls are positioned between the first rolls and the second rolls and urged by a spring against the first rolls and the second rolls.

12. The shrimp peeling machine according to claim 11, wherein the activation element comprises a first toothed belt and a second toothed belt, and wherein the first toothed belt and the second toothed belt are driven by the first motor device and that the first toothed belt drives the first rolls and that the second toothed belt drives the second rolls.

13. The shrimp peeling machine according to claim 11, wherein the first items comprise a first toothed wheel having a number of teeth t1 and connected to the first rolls, and wherein the second items comprise a second toothed wheel having a number of teeth t2 connected to the second rolls, wherein the number of teeth t1 and t2 and the diameters D1 and D2 are designed such that the peripheral rotational speed for the first rolls and the second rolls are the same when the first toothed wheel and second toothed wheel are in mesh with the first toothed belt and the second toothed belt respectively.

14. The shrimp peeling machine according to claim 13, wherein the diameter D1 is smaller than the diameter D2 and that the number of teeth t1 is smaller than the number of teeth t2.

15. The shrimp peeling machine according to claim 13, wherein the first toothed wheel is in mesh with the firth toothed belt in the peeling area, the second toothed wheel is in mesh with the second toothed belt in the peeling area, and wherein the first toothed wheel and second toothed wheel are configured to not touch each other.

16. The shrimp peeling machine according to claim 11, wherein the first motor device is a servo gear, which can be programmed to a random propulsion of the activation element, by which the first rolls and the second rolls rotate opposite each other in the interval 10 degrees to infinite in one direction and in the interval 10 degrees to infinite in the opposite direction, and by which rotations the third rolls turn around in the shrimp peeling area.

17. The shrimp peeling machine according to claim 11, wherein the first rolls and the second rolls have a polymeric surface, and wherein the third rolls have a metallic surface.

18. The shrimp peeling machine according to claim 11, wherein the closed chain is designed to run continuously forwards and that the first rolls and second rolls in the peeling area are designed to rotate in changing directions and opposite each other, by which rotation the third rolls turn around.

19. The shrimp peeling machine according to claim 11, wherein the first rolls form a first plane and the second rolls form a second plane, and wherein the first plane in the peeling area in vertical direction is placed above the second plane.

20. The shrimp peeling machine according to claim 11, wherein the shrimp peeling machine further comprises a cleaning station, which cleaning station is placed under the peeling area.

21. The shrimp peeling machine according to claim 11, wherein the first motor device is a servo gear, which can be programmed to a random propulsion of the activation element, by which the first rolls and the second rolls rotate opposite each other in the interval 20 degrees to 30,000 degrees in one direction and in the interval 20 degrees to 30,000 degrees in the opposite direction, and by which rotations the third rolls turn around in the shrimp peeling area.

22. The shrimp peeling machine according to claim 11, wherein the first motor device is a servo gear, which can be programmed to a random propulsion of the activation element, by which the first rolls and the second rolls rotate opposite each other in the interval 180 degrees to 20,000 degrees in one direction and in the interval 180 degrees to 20,000 degrees in the opposite direction, and by which rotations the third rolls turns around in the shrimp peeling area.
